(19) United States
(12) Patent Application Publication
(10) Pub. No.: US 2026/0177811 A1
(43) Pub. Date: Jun. 25, 2026

(54) SCANNING MIRROR DEVICE HAVING LIGHT SOURCE COMPONENTS

(71) Applicant: BO-WEN CHENG, TAOYUAN CITY (TW)

(72) Inventors: BO-WEN CHENG, TAOYUAN CITY (TW); CHEN-PANG WU, HSINCHU CITY (TW)

(21) Appl. No.: 18/989,757

(22) Filed: Dec. 20, 2024

(51) Int. Cl. G02B 26/10; G02B 26/08

(52) U.S. Cl. CPC G02B 26/101; G02B 26/0816

(57) ABSTRACT

A scanning mirror device having light source components is disclosed. The scanning mirror device includes a scanning mirror body, having a mirror surface; a plurality of light source components, disposed on the mirror surface; an actuator unit, connected to the scanning mirror body; and a torsion axle, connected to the scanning mirror body. There is no need for additional lens and mirror structures, so the volume can be reduced greatly.

### FIELD OF THE INVENTION

The present invention relates to a scanning mirror device, and more particularly to a scanning mirror device having light source components.

### BACKGROUND OF THE INVENTION

Scanning mirrors, especially micro scanning mirrors (MEMS scanning mirrors), have been widely used in different fields such as projection displays.

Specific technologies disclosed in a master's thesis “Design of Torsional Spring for the LiDAR Performance Enhancement of Single Axis Piezoelectric MEMS Scanning Mirror” written by Ming-Wei Wang, National Tsing Hua University, which set forth various electrostatic actuated micro scanning mirrors, electromagnetic actuated micro scanning mirrors, piezoelectric actuated micro scanning mirrors, and so on.

However, in the aforementioned paper, no matter which actuation manner is used, the light source of the conventional micro scanning mirror is disposed on the outside of the micro scanning mirror, which often needs to cooperate with other lenses for focusing and additional mirrors for changing the light path. The overall volume is relatively large.

### SUMMARY OF THE INVENTION

The primary object of the present invention is to provide a scanning mirror device having light source components. The scanning mirror device comprises a scanning mirror body, a plurality of light source components, an actuator unit, and a torsion axle. The scanning mirror body has a mirror surface. The plurality of light source components are embedded in the mirror surface using a heterogeneous integration process or fixed to the mirror surface. The actuator unit is connected to the scanning mirror body. The torsion axle is connected to the scanning mirror body. When the actuator unit is activated, the actuator unit drives the scanning mirror body to generate a torsional motion via the torsion axle, the light source components emit a light, and the light emitted from the light source components directly leaves the scanning mirror body.

Preferably, the scanning mirror body includes a reflective mirror and a sensor unit. The reflective mirror has the mirror surface. The sensor unit is configured for detecting an incident light reflected back from outside of the scanner body.

Preferably, the sensor unit includes a photodiode and/or a photosensitive coating.

Preferably, the reflective mirror is not limited to being circular.

Preferably, the light source components include lasers and/or light-emitting diodes.

Preferably, the actuator unit includes a piezoelectric actuator and an actuator spring. The actuator spring connects the piezoelectric actuator and the scanning mirror body.

Preferably, the torsion axle is a torsion spring.

According to the above technical features, the present invention can achieve the following effects:
1. Because the light source components are directly disposed on the mirror surface, there is no need for additional lens and mirror structures. The volume can be reduced greatly.
2. Because the light source components are directly disposed on the mirror surface, the reflective mirror is not limited to being circular.

### BRIEF DESCRIPTION OF THE DRAWINGS

FIG. 1 is a perspective view according to a first embodiment of the present invention;

FIG. 2 is a planar view according to the first embodiment of the present invention;

FIG. 3 is a planar view according to a second embodiment of the present invention;

FIG. 4 is a perspective view according to a third embodiment of the present invention; and

FIG. 5 is a planar view according to the third embodiment of the present invention.

### DESCRIPTION OF THE PREFERRED EMBODIMENTS

Embodiments of the present invention will now be described, by way of example only, with reference to the accompanying drawings.

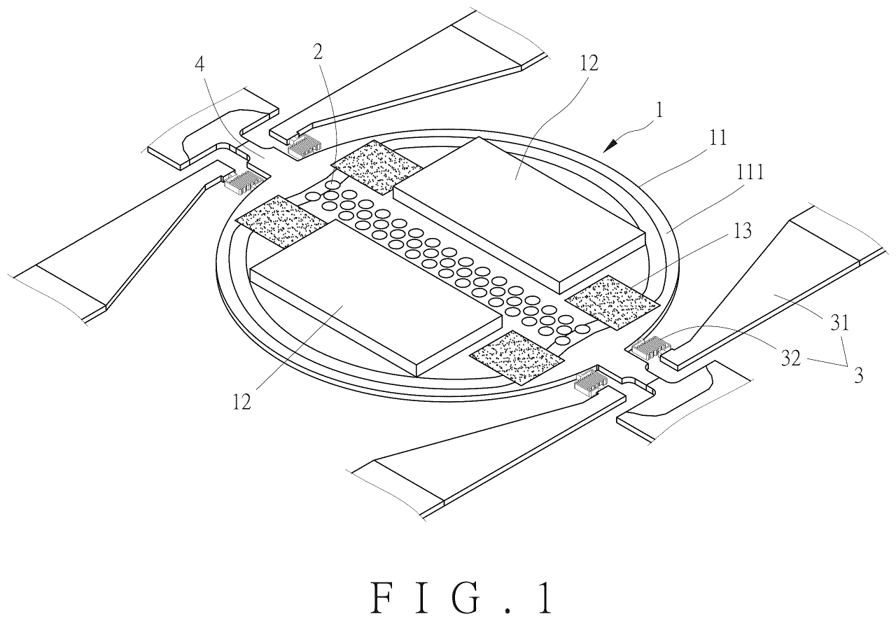

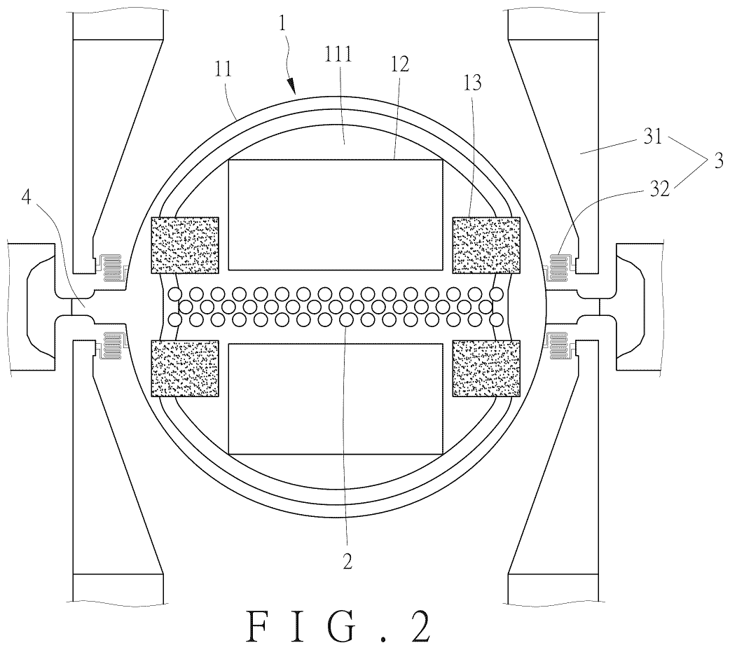

The present invention discloses a scanning mirror device having light source components. FIG. 1 and FIG. 2 illustrate a first embodiment of the present invention. The scanning mirror device comprises a scanning mirror body 1, a plurality of light source components 2, an actuator unit 3, and a torsion axle.

The scanning mirror body 1 includes a reflective mirror 11 and a sensor unit. The reflective mirror 11 has a mirror surface 111. Preferably, the reflective mirror 11 is a plane mirror. The mirror surface 111 has a reflection function. The sensor unit includes a photodiode 12 and a photosensitive coating 13. The sensor unit may include a plurality of photodiodes 12 and a plurality of sections of the photosensitive coating 13 that are arranged together. In actual implementation, the sensor unit may include a single photodiode 12 or a single section of the photosensitive coating 13, but not limited thereto.

The plurality of light source components 2 are disposed on the mirror surface 111. Preferably, the light source components 2 may be lasers or light-emitting diodes, or a combination of lasers and light-emitting diodes. The light source components 2 have three rows of colored lights (R, G, B), each arranged in a single row. As shown in the drawings, the light source components 2 are simply illustrated in the form of circles without thickness. In actual implementation, the light source components 2 may be embedded in the reflective mirror 11 using a heterogeneous integration process or simply fixed on the surface of the reflective mirror 11.

The actuator unit 3 is connected to the scanning mirror body 1. The actuator unit 3 includes a piezoelectric actuator 31 and an actuator spring 32. The actuator spring 32 connects the piezoelectric actuator 31 and the scanning mirror body 1.

The torsion axle is connected to the scanning mirror body 1. Preferably, the torsion axle is a torsion spring 4.

After the piezoelectric actuator 31 is activated, the piezoelectric actuator 31 drives the scanning mirror body 1 through the actuator spring 32 to generate a torsional motion via the torsion axle. The light source components 2 emit a light that directly leaves the scanning mirror body 1. The sensor unit, such as the photodiode 12 and/or the photosensitive coating 13, detects an incident light reflected back from outside of the scanning mirror body 1 and incident on the scanning mirror body 1.

In detail, after the light emitted from the light source components 2 enters an object to be measured (not shown), such as the eyeball of a living body, an integrated circuit, or a III-V material, the backward scattering light will be scattered back to the mirror surface 111 along the original optical path and will be detected by the sensor unit. By means of a processing unit (not shown), the characteristics of the object to be measured, such as the position of the eyeball, eye lesions, the location of defects in the integrated circuit, etc., can be known.

In actual implementation, other light sources outside the scanning mirror body 1 can be used. The mirror surface 111 reflects the incident light, such as light from other light sources or the above-mentioned backward scattering light, incident from outside of the scanning mirror body 1 away from the scanning mirror body for a wider range of applications. Even if the mirror surface 111 has no reflection function, the scanning mirror device with the light source components can still achieve the purpose of scanning.

In particular, the main technical feature of the present invention is that the light source components 2 are disposed on the mirror surface 111, not improving the piezoelectric actuator 31, the actuator spring 32, the torsion spring 4 of the existing structure of the piezoelectric actuated micro scanning mirror. Those with ordinary knowledge in this technical field can implement the scanning mirror device with light source components according to the prior art such as the aforementioned paper. The present invention will not elaborate on the above-mentioned existing structure, the inherent structure or function of the conventional piezoelectric actuated micro scanning mirror, but will simply summarize as described above.

The wiring for supplying power to each component is not shown in the drawings of the present invention. Taking the light source components 2 as an example, those with ordinary knowledge in this technical field can separate the wiring of the light source components 2 from the wiring of the piezoelectric actuator 31 according to actual needs, and the wiring of the light source components 2 is wound around the torsion spring 4 or the actuator spring 32 to connect to an external power source or battery. The wiring of the light source components 2 is not limited to a single one.

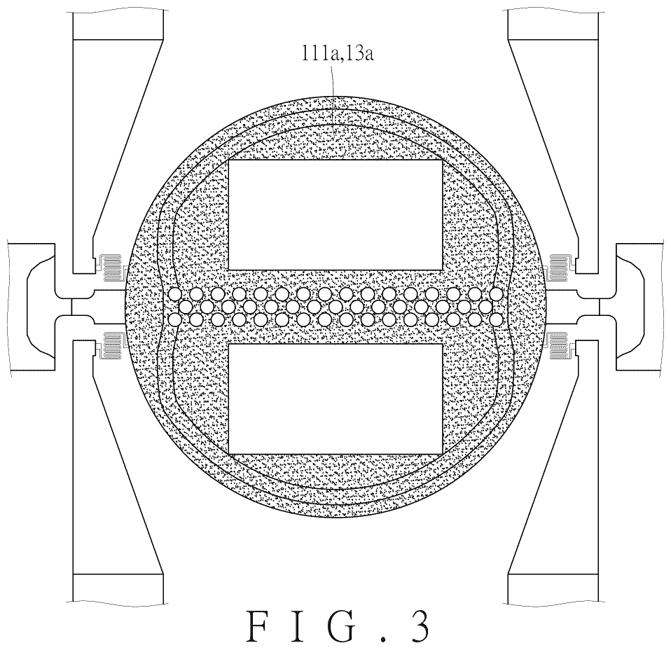

FIG. 3 illustrates a second embodiment of the present invention. The second embodiment is substantially similar to the first embodiment with the exceptions described hereinafter.

In the first embodiment as shown in FIG. 1, the photosensitive coating 13 is in the form of a plurality of square areas. In the second embodiment, the photosensitive coating 13a covers the entire mirror surface 111a, increasing the photosensitive area greatly. The other configurations are the same as or correspond to the first embodiment and will not be repeated here.

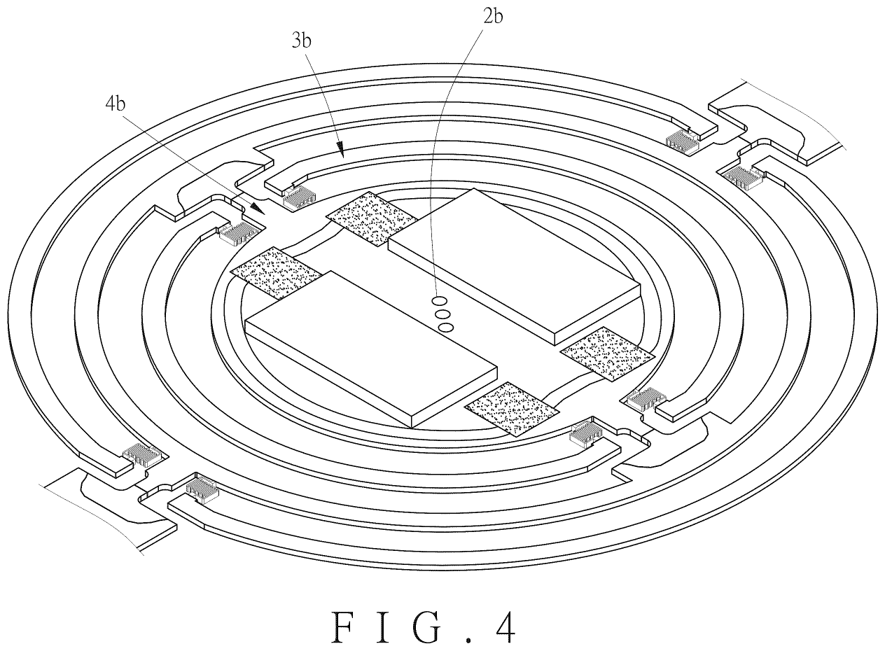

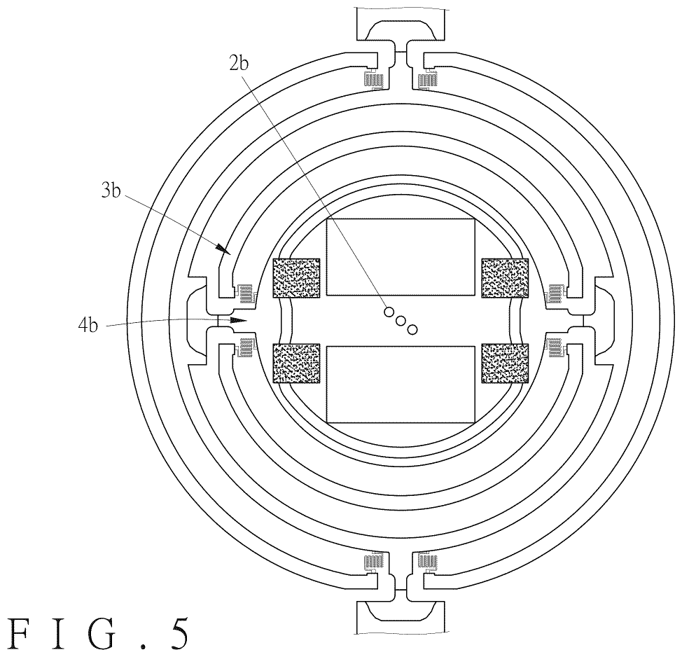

FIG. 4 and FIG. 5 illustrate a third embodiment of the present invention. The third embodiment is substantially similar to the first embodiment with the exceptions described hereinafter.

In the first embodiment as shown in FIG. 1, the light source components 2 have three rows of colored lights (R, G, B), each arranged in a single row. In the third embodiment, the light source components 2b also have three colored lights (R, G, B) each having only one. The light source components 2b may be arranged horizontally, vertically or obliquely.

In the third embodiment, since the light source components 2b have three colored lights (R, G, B) each having only one, the actuator units 3b and the torsion springs 4b are preferably arranged in two sets to control the action in two directions, thereby achieving the scanning of the surface. The other configurations are the same as or correspond to the first embodiment and will not be repeated here.

Referring to FIG. 1 and FIG. 2, because the light source components 2 are directly disposed on the mirror surface 111 without additional lens and mirror structures, the overall volume of the module or system can be reduced greatly, which is more suitable for applications with limited space such as eye tracking devices, augmented reality devices, virtual reality devices, head-up displays and other wearable devices, etc., and is beneficial to reduce the volume of various products.

In addition, because laser light is usually a circular spot, conventional reflective mirrors are limited to being in a circular shape in order to utilize most of the light better. In the present invention, the light source components 2 are directly disposed on the mirror surface 111. The shape of the reflective mirror 11 can be determined according to the size and arrangement of the light source components 2, and is no longer limited to a circle.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A scanning mirror device, comprising:
a scanning mirror body, having a mirror surface;
a plurality of light source components, embedded in the mirror surface using a heterogeneous integration process or fixed to the mirror surface;
an actuator unit, connected to the scanning mirror body; and
a torsion axle, connected to the scanning mirror body;
wherein when the actuator unit is activated, the actuator unit drives the scanning mirror body to generate a torsional motion via the torsion axle, the light source components emit a light, and the light emitted from the light source components directly leaves the scanning mirror body.

2. The scanning mirror device as claimed in claim 1, wherein the scanning mirror body includes a sensor unit, and the sensor unit is configured for detecting an incident light incident from outside of the scanner body.

3. The scanning mirror device as claimed in claim 2, wherein the sensor unit includes a photodiode and/or a photosensitive coating.

4. The scanning mirror device as claimed in claim 1, wherein the scanning mirror body includes a reflective mirror, the reflective mirror has the mirror surface, the mirror surface has a reflection function, and the mirror surface reflects an incident light incident from outside of the scanning mirror body away from the scanning mirror body.

5. The scanning mirror device as claimed in claim 4, wherein the reflective mirror is not limited to being circular.

6. The scanning mirror device as claimed in claim 1, wherein the light source components include lasers and/or light-emitting diodes.

7. The scanning mirror device as claimed in claim 1, wherein the actuator unit includes a piezoelectric actuator and an actuator spring, and the actuator spring connects the piezoelectric actuator and the scanning mirror body.

8. The scanning mirror device as claimed in claim 1, wherein the torsion axle is a torsion spring.
